(19) United States
(12) Patent Application Publication
(10) Pub. No.: US 2009/0022185 A1
(43) Pub. Date: Jan. 22, 2009

(54) METHOD OF CONTROLLING SEMICONDUCTOR LASER

(75) Inventors: Toyotoshi MACHIDA, Yamanashi (JP); Tsutomu ISHIKAWA, Yamanashi (JP); Hirokazu TANAKA, Yamanashi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: EUDYNA DEVICES INC., Yamanashi (JP)

(21) Appl. No.: 12/175,619

(22) Filed: Jul. 18, 2008

(30) Foreign Application Priority Data
Jul. 19, 2007 (JP) 2007-188880

(51) Int. Cl. H01S 3/10

(52) U.S. Cl. 372/20; 372/34

(57) ABSTRACT

A method of controlling a semiconductor laser having a wavelength selection portion, a refractive index of the wavelength selection portion being controllable with a heater including: a starting sequence including a first step for adjusting a heat value of the heater until the heat value of the heater reaches a given value; and a wavelength control sequence including a second step for correcting a wavelength of the semiconductor laser according to a detection result of an oscillation wavelength of the semiconductor laser after the starting sequence.

### BACKGROUND OF THE INVENTION

1. Field of the Invention

The present invention relates a method of controlling a semiconductor laser.

2. Description of the Related Art

A wavelength tunable semiconductor laser is one of optical devices. The wavelength tunable semiconductor laser has a gain for a laser oscillation and selects wavelength. There is a method of tuning wavelength characteristics of loss, reflection or gain by tuning refractive index of an optical functional region such as a diffractive grating provided in an optical waveguide in a resonator, as a method of selecting wavelength.

The method of tuning the refractive index does not need a mechanical movable portion, being different from a method of tuning a mechanical angle or a mechanical length. Therefore, the method has an advantage in reliability and a manufacturing cost. There is a method of tuning a temperature of an optical waveguide, a method of tuning a carrier density in an optical waveguide with current injection or the like, as a method of tuning refractive index of an optical waveguide. There is proposed a semiconductor laser having a Sampled Grating Distributed Bragg Reflector (SG-DBR) in which peak wavelength of reflection peak ranges periodically and a Sampled Grating Distributed Feedback (SG-DFB) in which peak wavelength of gain spectrum ranges periodically, as a concrete example of a wavelength tunable laser adopting a method of tuning a temperature of an optical waveguide.

This semiconductor laser controls a correlation between the reflection spectrums of the SG-DBR and the SG-DFB, selects a wavelength with a vernier effect, and emits a laser light. That is, the semiconductor laser oscillates at one of wavelengths where two spectrums are overlapped and reflection intensity gets biggest. It is therefore possible to control the oscillation wavelength by controlling the correlation of two reflection spectrums.

Japanese Patent Application Publication No. 9-92934 (hereinafter referred to as Document 1) discloses a semiconductor laser controlling an oscillation wavelength with a control of refractive index of an optical waveguide. In Document 1, a heater is adopted as a control portion of the refractive index of the optical waveguide. The wavelength is controlled with a control of a temperature control of the optical waveguide with use of the heater.

Degradation of the heater is a problem, in a case where the heater is used for a control of the refractive index of the optical waveguide. Heat value of the heater may be changed even if a constant current is provided to the heater, when a resistance of the heater changes because of the degradation of the heater. In particular, temperature differential between each optical waveguide is important and the unexpected changing of the heat value is fatal, in an optical device that has a combination of the optical waveguides having different wavelength property from each other such as a combination of the SC-DFB and the SG-DBR.

The width of temperature range (ΔT) of the heater for controlling the temperature of the optical waveguide is approximately 40 degrees. The temperature of the heater is relatively low. Therefore, the degradation of the heater has not been considered.

The degradation of the heater is difficult to be exposed, in a case where the semiconductor laser is used continuously. FIG. 1 illustrates a relation between the temperature of the heater and the oscillation wavelength of the semiconductor laser. A horizontal axis of FIG. 1 indicates the temperature of the heater. A vertical axis of FIG. 1 illustrates the oscillation wavelength of the semiconductor laser. For example, the semiconductor laser oscillates at a wavelength where two of the reflection spectrums of the SG-DBR region and the SG-DFB region are overlapped. Therefore, the oscillation wavelength of the semiconductor laser profiles at a given wavelength interval. In FIG. 1, flat portions (λ1 to λ4) are wavelengths where the semiconductor laser may oscillate.

The temperature of the heater is set within a temperature range R of FIG. 1, in order to set the oscillation wavelength of the semiconductor laser to be λ2. For example, a current is provided to the heater so that the temperature of the heater is at a temperature T that is a middle of the temperature range R. However, the resistance of the heater changes if the heater is degraded. In this case, the heat value of the heater changes. That is, the semiconductor laser may oscillate at a wavelength other than λ2 when the temperature of the heater is away from the temperature T.

However, a semiconductor laser adopting a feedback system fox detecting an output wavelength and correcting the wavelength has a wavelength locker for correcting the output wavelength of the semiconductor laser. The wavelength locker controls temperature of the temperature control device and changes the gain spectrum of the SG-DFB region to be matched with a desirable wavelength λ2. Therefore, the oscillation wavelength of the semiconductor laser is kept to be λ2 when the temperature of the heater is within the temperature range R, even if the heater is degraded and the temperature of the heater is different from the temperature T. That is, the degradation of the heater is difficult to be exposed because the output wavelength is stabilized even if the heater is gradually degraded, when the wavelength is continuously corrected.

On the other hand, the problem is exposed when the system is shut down for maintenance. A current value of the heater and a temperature of the temperature control device are loaded from a look-up table when the system is restarted. A setting value of the look-up table is an initial value on condition that the heater is not degraded. Therefore, the temperature of the heater is different from the temperature T if the heater is degraded. On the other hand, the temperature value of the look-up table is an initial value. Therefore, the gain spectrum of the SG-DFB region is different from the spectrum of a case where the wavelength locker corrects a wavelength.

For example, the semiconductor laser may oscillate at an expected wavelength λ2 when the heater is little degraded and the initial temperature of the heater is within the temperature range R. However, the semiconductor laser may oscillate at another wavelength, because the temperature T is not obtained because of the degradation of the heater. For example, the semiconductor laser may oscillate at other than the wavelength λ2, if the initial temperature value of the temperature control device and the initial current value of the SG-DFB are not given to the laser chip accurately. That is, the oscillation wavelength is susceptible to the parameter movement.

The semiconductor laser may not oscillate at the wavelength λ2 even if the other parameter is controlled accurately, when the heater is degraded and the temperature of the heater is out of the temperature range R. At any rate, it is difficult to obtain the desired wavelength at the restarting if the heater is degraded.

### SUMMARY OF THE INVENTION

The present invention has been made in view of the above circumstances and provides a method of controlling a semiconductor laser that obtains a desired wavelength even if the heater is degraded.

According to an aspect of the present invention, there is provided a method of controlling a semiconductor laser having a wavelength selection portion, a refractive index of the wavelength selection portion being controllable with a heater including: a starting sequence including a first step for adjusting a heat value of the heater until the heat value of the heater reaches a given value; and a wavelength control sequence including a second step for correcting a wavelength of the semiconductor laser according to a detection result of an oscillation wavelength of the semiconductor laser after the starting sequence.

With the method, the heat value of the heater is accurately corrected before the wavelength control sequence. In this case, optical property of the wavelength selection portion is substantially the same as a case where the heater is little degraded, even if the heater is degraded. Therefore, it is possible to obtain a desirable oscillation wavelength.

### BRIEF DESCRIPTION OF THE DRAWINGS

Other objects, features and advantages of the present invention will become more apparent from the following detailed description when read in conjunction with the accompanying drawings, in which:

FIG. 1 illustrates a relation between a temperature of a heater and an oscillation wavelength of a semiconductor laser;

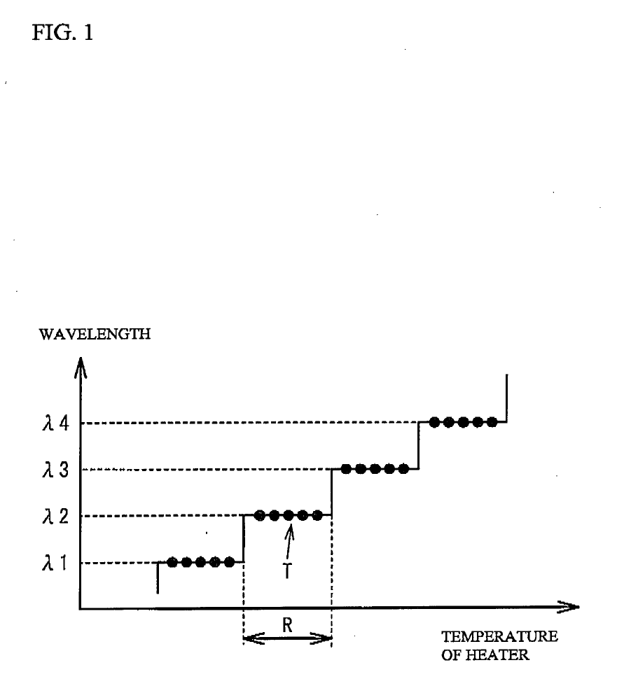

FIG. 2 illustrates a semiconductor laser in accordance with a first embodiment and a structure of a laser device having the semiconductor laser;

FIG. 3 illustrates an example of a look-up table;

FIG. 4 illustrates a flowchart showing an example of a controlling method of the laser device; and

FIG. 5 illustrates a flowchart showing an example of a controlling method in a case where a semiconductor laser is dark-tuned.

### DESCRIPTION OF THE PREFERRED EMBODIMENTS

A description will now be given of embodiments of the present invention with reference to the accompanying drawings.

### First Embodiment

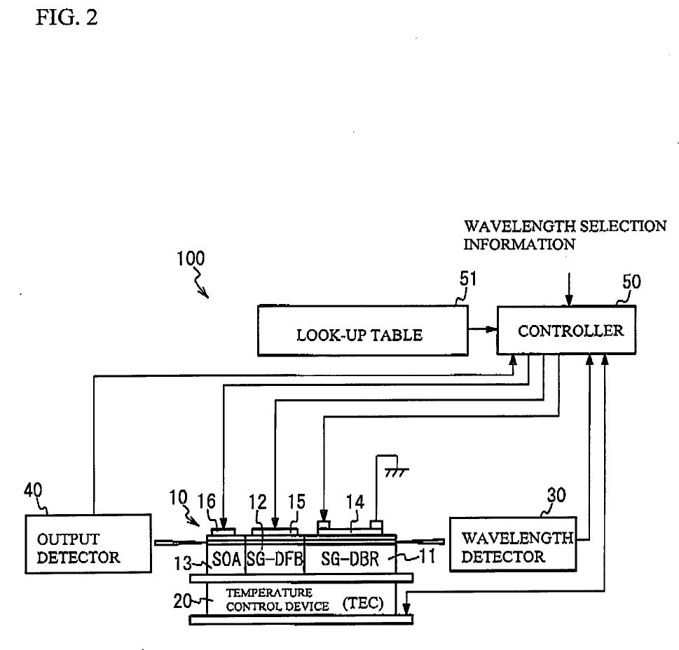

FIG. 2 illustrates a semiconductor laser 10 in accordance with a first embodiment and a structure of a laser device 100 having the semiconductor laser 10. As shown in FIG. 2, the laser device 100 has the semiconductor laser 10, a temperature control device 20, a wavelength detector 30, an output detector 40 and a controller 50. The semiconductor laser 10 is mounted on the temperature control device 20. A description will be given of each part.

The semiconductor laser 10 has a structure in which a SG-DBR region 11, a SG-DFB region 12 and a semiconductor amplifier (SOA: Semiconductor Optical Amplifier) region 13 are coupled in order. The SG-DBR region 11 has an optical waveguide in which gratings are provided at a given interval. That is, the optical waveguide of the SG-DBR region 11 has a first region that has a diffractive grating and a second region that is optically connected to the first region and acts as a spacer. The optical waveguide of the SG-DBR region 11 is composed of semiconductor crystal having an absorption edge wavelength at shorter wavelengths side compared to a laser oscillation wavelength. A heater 14 is provided on the SG-DBR region 11.

The SG-DFB region 12 has an optical waveguide in which gratings are provided at a given interval. That is, the optical waveguide of the SG-DFB region 12 has a first region that has a grating and a second region that is optically connected to the first region and acts as a spacer. The optical waveguide of the SG-DFB region 12 is composed of semiconductor crystal amplifying a light of a desirable wavelength of a laser oscillation. An electrode 15 is provided on the SG-DFB region 12. The SOA region 13 has an optical waveguide composed of semiconductor crystal for amplifying a light or for absorbing a light with a current control. An electrode 16 is provided on the SOA region 13. The optical waveguides of the SG-DBR region 11, the SG-DFB region 12 and the SOA region 13 are optically connected to each other.

The semiconductor laser 10 is mounted on the temperature control device 20. A thermistor (not shown) for detecting the temperature of the temperature control device 20 is provided on the temperature control device 20. The wavelength detector 30 has a light receiving element for detecting an intensity of a lasing light and a light receiving element for detecting an intensity of a lasing light that transmits an etalon and has wavelength property. The output detector 40 has a light receiving element for detecting an intensity of a lasing light passing through the SOA region 13. In FIG. 2, the wavelength detector 30 is arranged on the side of the SG-DBR region 11, and the output detector 40 is arranged on the side of the SOA region 13. However, the structure of the semiconductor laser 10 is not limited. For example, each of the detectors may be arranged in reverse.

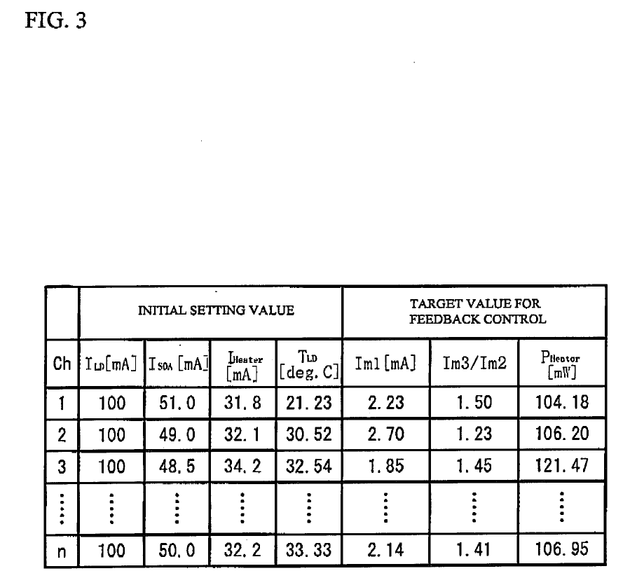

The controller 50 has a control portion having a central processing unit (CPU), a random access memory (RAM), a read only memory (ROM) and so on and an electrical power supply. The ROM of the controller 50 stores control information and a control program of the semiconductor laser 10. The control information is, for example, stored in a look-up table 51. FIG. 3 illustrates an example of the look-up table 51.

As shown in FIG. 3, the look-up table 51 includes an initial setting value and a target value for feedback control in every channel. The initial setting value includes an initial current value I_{LD} of the SG-DFB region 12, an initial current value I_{SOA} of the SOA region 13, an initial current value I_{Heater} of the heater 14 and the initial temperature value T_{LD} of the temperature control device 20. The target value for the feedback control includes a target value Im1 for feedback control of the output detector 40, a target value Im3/Im2 for feedback control of the wavelength detector 30 and a target value P_{Heater} for feedback control of electrical power of the heater 14.

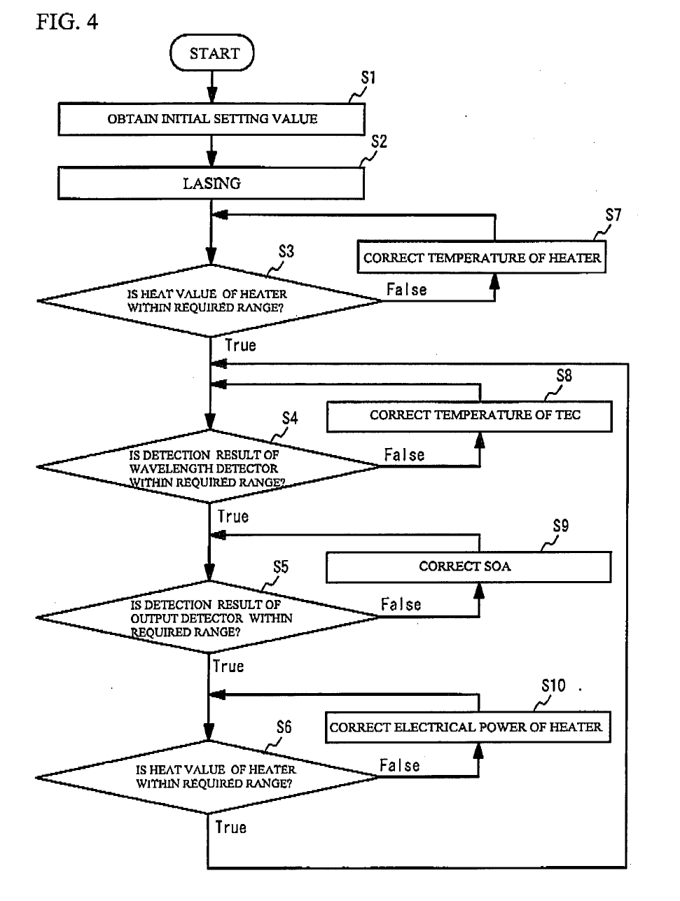

Next, a description will be given of a controlling method of the laser device 100. FIG. 4 illustrates a flowchart showing a controlling method of the semiconductor laser 10. As shown in FIG. 4, the controller 50 refers to the look-up table 51 and obtains the initial current value I_{LD}, the initial current value I_{SOA}, the initial current value I_{Heater} and the initial temperature value T_{LD} (Step S1).

Next, the controller 50 starts a laser oscillation of the semiconductor laser 10 according to the initial setting value obtained in the Step S1 (Step S2). In concrete, the controller 50 controls the temperature control device 20 so that the temperature of the temperature control device 20 is controlled to be the initial temperature value T_{LD}. And the temperature of the semiconductor laser 10 is controlled to be constant near the initial temperature value T_{LD}. Consequently the equivalent refractive index of the optical waveguide of the SG-DFB region 12 is controlled. Next, the controller 50 provides a current of the initial current value I_{LD} to the electrode 15. And a light is generated in the optical waveguide of the SG-DFB region 12. The light generated in the SG-DFB region 12 is repeatedly reflected and amplified in the optical waveguide of the SG-DBR region 11 and the SG-DFB region 12. This results in a laser oscillation. Next, the controller 50 provides a current of the initial current value I_{Heater} to the heater 14. Therefore, the equivalent refractive index of the optical waveguide of the SG-DBR region 11 is controlled to be a given value. Then, the controller 50 provides a current of the initial current value I_{SOA} to the electrode 16. With the control, the semiconductor laser 10 emits a lasing light at an initial wavelength corresponding to a set channel.

Then, the controller 50 determines whether the heat value of the heater 14 is within a required range according to an electrical power obtained with a voltage applied between both ends of the heater 14 and a current provided to the heater 14 (Step S3). In concrete, the controller 50 obtains the target value P_{Heater} for feedback control from the look-up table 51. After that, the controller 50 determines whether the electrical power obtained with detected voltage of the heater 14 and the current provided to the heater 14 is within a given range including the target value P_{Heater} for feedback control.

If it is not determined that the heat value of the heater 14 is within the required range in the Step S3, the controller 50 corrects the temperature of the heater 14 (Step S7). The temperature of the heater 14 is corrected when the current provided to the heater 14 is changed and the electrical power obtained with the current provide do the heater 14 and the voltage applied between the both ends of the heater 14 is changed. After that, the controller 50 executes the Step S3 again. With the loop, the heat value of the heater 14 is feedback controlled so as to be within the required range.

Next, the controller 50 determined whether the wavelength of the lasing light is within a required range according to the detection result of the wavelength detector 30 (Step S4). In concrete, the controller 50 obtains the target value Im3/Im2 for feedback control from the look-up table 51, obtains a ratio Im3/Im2 of the two light receiving elements in the wavelength detector 30 and determines whether the ratio Im3/Im2 is within a given range including the target value Im3/Im2 for feedback control.

If it is not determined that the wavelength of the lasing light is within the required range in the Step S4, the controller 50 corrects the temperature of the temperature control device 20 (Step S8). In this case, peak wavelength of a gain spectrum in the optical waveguide in the SG-DFB region 12 changes. After that, the controller 50 executes the Step S4 again. With the loop, the wavelength of the lasing light is feedback controlled to be kept a desired constant value.

If it is determined that the wavelength of the lasing light is within the required range in the Step S4, the controller 50 determines whether the optical intensity of the lasing light is within a required range (Step S5). In concrete, the controller 50 obtains the target value Im1 for feedback control from the look-up table 51, obtains the detection result Im1 of the light receiving element in the output detector 40, and determines whether the detection result Im1 is within a given range including the target value Im1 for feedback control.

If it is not determined that the optical intensity of the lasing light is within the required range in the Step S5, the controller 50 corrects the current provided to the electrode 16 (Step S9). After that, the controller 50 executes the Step S5 again. With the loop, the optical intensity of the lasing light is feedback controlled to be a desired constant value.

If it is determined that the optical intensity of the lasing light is within the required range in the Step S5, the controller 50 determines whether the heat value of the heater 14 is within a required range (Step S6). In concrete, the controller 50 obtains the target value P_{Heater} from the look-up table 51, obtains the voltage applied between the both ends of the heater 14, and determines whether the electrical power calculated with the voltage and the current value provide to the heater 14 is within a required range including the target value P_{Heater} for feedback control.

If it is not determined that the heat value of the heater 14 is within the required range in the Step S6, the controller 50 corrects the electrical power to the heater 14 (Step S10). In this case, the electrical power is corrected when at least one of the current and the voltage is corrected. In the embodiment, the controller 50 corrects the electrical power by increasing and decreasing the current value provided to the heater 14. With the loop, the electrical power provided to the heater 14 is feedback controlled so that the electrical power provided to the heater 14 is controlled to be within the required range. If it is determined that the electrical power provided to the heater 14 is within the required range in the Step S6, the controller 50 executes the Step S4 again.

In the embodiment, the heat value of the heater 14 is corrected accurately before the wavelength is controlled with the wavelength detector 30. In this case, the heat value of the heater 14 is substantially the same as a case where the heater is little degraded, even if the heater 14 is degraded. Therefore, the optical property of the SG-DBR region 11 is substantially the same as a case where the heater 14 is little degraded. This results in a desirable wavelength according to the initial setting value.

In the flowchart in FIG. 4, the oscillation wavelength and the intensity of the emitted light are controlled. However, the flowchart is not limited. Another micro controller may execute the loop of the Step S4 through the Step S8 or the loop of the Step S5 and the Step S9.

Next, a description will be given of a method of controlling the laser device 100 in a case of dark tuning. The dark tuning is a method of forbidding the optical output until the lasing wavelength reaches the required wavelength range. In the embodiment, the lasing wavelength of the semiconductor laser 10 is adjusted under a condition where a reverse voltage is applied to the SOA region 13 and the optical output is forbidden.

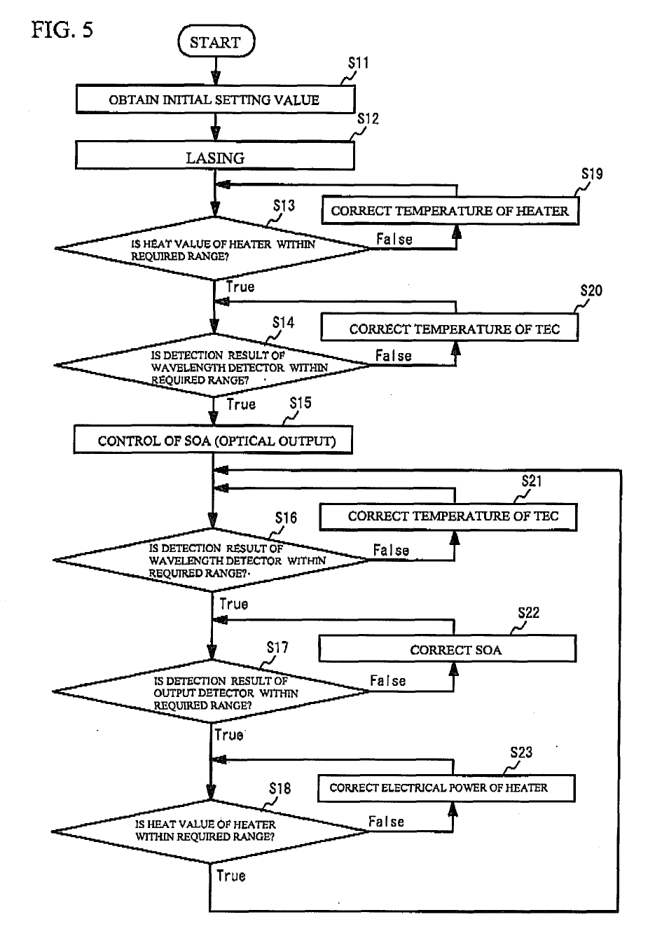

FIG. 5 illustrates a flowchart showing an example of the dark tuning of the laser device 100. As shown in FIG. 5, the controller 50 refers to the look-up table 51 and obtains the initial current value I_{LD}, the initial current value I_{SOA}, the initial current value I_{Heater} and the initial temperature value T_{LD} (Step S1).

Next, the controller 50 starts a laser oscillation of the semiconductor laser 10 according to the initial setting value obtained in the Step S11 (Step S12). In concrete, the controller 50 controls the temperature control device 20 so that the temperature of the temperature control device 20 is controlled to be the initial temperature value T_{LD}. Next, the controller 50 provides a current of the initial current value I_{LD} to the electrode 15. Next, the controller 50 provides a current of the initial current value I_{Heater} to the heater 14. Then, the light generated in the SG-DFB region 12 is repeatedly reflected and amplified in the optical waveguide of the SG-DBR region 11 and the SG-DFB region 12. This results in a laser oscillation.

Then, the controller 50 determines whether the heat value of the heater 14 is within a required range (Step S13). In concrete, the controller 50 obtains the target value P_{Heater} for feedback control from the look-up table 51. After that, the controller 50 determines whether the electrical power obtained with detected voltage of the heater 14 and the current provided to the heater 14 is within a given range including the target value P_{Heater} for feedback control.

If it is not determined that the heat value of the heater 14 is within the required range in the Step S13, the controller 50 corrects the temperature of the heater 14 (Step S19). After that, the controller 50 executes the Step S3 again.

Next, the controller 50 determines whether the wavelength of the lasing light is within a required range according to the detection result of the wavelength detector 30 (Step S14). In concrete, the controller 50 obtains the target value Im3/Im2 for feedback control from the look-up table 51, obtains a ratio Im3/Im2 of the two light receiving elements in the wavelength detector 30 and determines whether the ratio Im3/Im2 is within a given range including the target value Im3/Im2 for feedback control.

If it is not determined that the wavelength of the lasing light is within the required range in the Step S14, the controller 50 corrects the temperature of the temperature control device 20 (Step S20). After that, the controller 50 executes the Step S14 again.

If it is determined that the wavelength of the lasing light is within the required range in the Step S14, the controller 50 provides a current of the initial current value I_{SOA} to the electrode 16 (Step S15). Therefore, the semiconductor laser 10 emits a laser light at the initial wavelength according to the set channel.

Next, the controller 50 determines whether the wavelength of the lasing light is within a required range according to the detection result of the wavelength detector 30 (Step S16), similarly to the Step S14. If it is not determined that the wavelength of the lasing light is within the required range in the Step S16, the controller 50 corrects the temperature of the temperature control device 20 (Step S21). After that, the controller 50 executes the Step S16 again.

If it is determined that the wavelength of the lasing light is within the required range in the Step 316, the controller 50 determines whether the optical intensity of the lasing light is within a required range (Step S17). In concrete, the controller 50 obtains the target value Im1 for feedback control from the look-up table 51, obtains the detection result Im1 of the light receiving element in the output detector 40, and determines whether the detection result Im1 is within a given range including the target value Im1 for feedback control.

If it is not determined that the optical intensity of the lasing light is within the required range in the Step S17, the controller 50 corrects the current provided to the electrode 16 (Step S22). After that, the controller 50 executes the Step S17 again.

If it is determined that the optical intensity of the lasing light is within the required range in the Step S17, the controller 50 determines whether the heat value of the heater 14 is within a required range (Step S18), similarly to the Step S13. If it is not determined whether the heat value of the heater 14 is within the required range in the Step S18, the controller 50 corrects the electrical power to the heater 14 (Step S23). After that, the controller 50 executes the Step S18 again. If it is determined whether the electrical power provided to the heat value of the heater 14 is within the required range in the Step S10, the controller 50 executes the Step S16 again.

With the flowchart of FIG. 5, the heat value of the heater 14 is corrected accurately before the wavelength is controlled with the wavelength detector 30. In this case, the heat value of the heater 14 is substantially the same as a case where the heater is little degraded, even if the heater 14 is degraded. Therefore, the optical property of the SG-DBR region 11 is substantially the same as a case where the heater 14 is little degraded. This results in a desirable wavelength according to the initial setting value.

In the embodiment, the semiconductor laser has a combination of the SG-DBR region and the SG-DFB region. However, the structure is not limited. For example, the present invention may be applied to a semiconductor laser in which an active region acting as a gain region is between a pair of SG-DBR regions. In this case, a heater is provided on each of the SG-DBR regions or one of the SG-DBR regions. In this case, it is possible to control in feedback so that the heat value of the heater is within the required range, if the thermistor detects the temperature of each heater.

The present invention may be applied to a CSG-DBR (Chirped Sampled Grating Distributed Bragg Reflector). In the CSG-DBR, space regions connecting gratings have a different length from each other, being different from the SG-DBR region. Therefore, there is wavelength dependence in a peak intensity of a reflection spectrum of the CSG-DBR region. In this case, the peak intensity of the reflection spectrum is enlarged in a given wavelength range. It is therefore possible to restrain an oscillation at a wavelength other than a desired wavelength, if a wavelength in a wavelength range having relatively high intensity is used as a lasing wavelength. In a case where the CSG-DBR is used, it is possible to control each temperature of the segment separately, if each heater is provided on each segment structured with the grating and the spacer portion.

In the above-mentioned embodiment, the heat value of the heater is detected by detecting the electrical power provided to the heater with use of a voltmeter, a current meter or an electrical power meter. However, the structure is not limited. For example, the heat value of the heater may be detected with use of a thermistor.

In the flowchart of FIG. 4, the Step S3 corresponds to the first step. The Steps S1 through S3 correspond to the starting sequence. The Step S4 corresponds to the second step. The Steps S4 through S6 correspond to the wavelength control sequence. The Step S6 corresponds to the third step. In the flowchart of FIG. 5, the Step S13 corresponds to the first step. The Steps S11 through S15 correspond to the starting sequence. The step S16 corresponds to the second step. The Steps S16 through S18 correspond to the wavelength control sequence. The Step S18 corresponds to the third step.

The present invention is not limited to the specifically disclosed embodiments, but include other embodiments and variations without departing from the scope of the present invention.

The present application is based on Japanese Patent Application No. 2007-188880 filed on Jul. 19, 2007, the entire disclosure of which is hereby incorporated by reference.

What is claimed is:

1. A method of controlling a semiconductor laser having a wavelength selection portion, a refractive index of the wavelength selection portion being controllable with a heater comprising:
a starting sequence including a first step for adjusting a heat value of the heater until the heat value of the heater reaches a given value; and
a wavelength control sequence including a second step for correcting a wavelength of the semiconductor laser according to a detection result of an oscillation wavelength of the semiconductor laser after the starting sequence.

2. The method as claimed in claim 1, wherein the heat value of the heater is adjusted by adjusting an electrical power to the heater in the first step.

3. The method as claimed in claim 1, wherein the heat value of the heater is adjusted by adjusting current provided to the heater until an electrical power obtained with a voltage between both ends of the heater and a current provided to the heater reaches a given value in the first step.

4. The method as claimed in claim 1, wherein the heat value is adjusted by adjusting an electrical power provided to the heater until an output of a temperature detector arranged near the heater reaches a given value.

5. The method as claimed in claim 1, wherein the wavelength control sequence includes a third step for controlling the heat value of the heater to correct the wavelength to a predetermined value.

6. The method as claimed in claim 1, wherein the semiconductor laser has a wavelength detector for detecting the oscillation wavelength.

7. The method as claimed in claim 1, wherein the semiconductor laser has an active region that has a diffractive grating and an optical waveguide that is optically connected to the active region and has a diffractive grating, equivalent refractive index of the optical waveguide being tunable with the heater.

8. The method as claimed in claim 7, wherein the diffractive grating of the active region and the optical waveguide has a first region that has a diffractive grating and a second region that is connected to the first region and acts as a spacer.

9. The method as claimed in claim 1, wherein the semiconductor laser has an active region and a pair of optical waveguides optically connected to both ends of the active region respectively, at least one of the optical waveguides having the heater for controlling equivalent refractive index thereof.

10. The method as claimed in claim 1 further comprising:
a dark tuning sequence for tuning the wavelength to a predetermined value under a condition where an optical output to outside is restrained, and performing the starting sequence; and
an optical output sequence outputting a light to outside with a wavelength selected in the dark tuning sequence being kept.
